(19) United States
(12) Patent Application Publication
(10) Pub. No.: US 2025/0055640 A1
(43) Pub. Date: Feb. 13, 2025

(54) TRANSMISSION OF UPLINK CONTROL INFORMATION VIA SET OF CHANNEL RESOURCES

(71) Applicant: Nokia Technologies Oy, Espoo (FI)

(72) Inventors: Kari Pekka PAJUKOSKI, Oulu (FI); Esa Tapani TIIROLA, Oulu (FI); Kari Juhani HOOLI, Oulu (FI); Pasi Eino Tapio KINNUNEN, Oulu (FI)

(21) Appl. No.: 18/721,838

(22) PCT Filed: Dec. 21, 2021
(86) PCT No.: PCT/EP2021/087025

§ 371 Date: Jun. 19, 2024

(51) Int. Cl. H04L 5/00; H04L 27/26

(52) U.S. Cl. CPC H04L 5/0053; H04L 27/2613

(57) ABSTRACT

A method includes performing channel encoding on a plurality of information bits to obtain a codeword that includes a plurality of code bits; segmenting the codeword into a plurality of segments of code bits; performing the following for each of the plurality of segments of code bits of the codeword: selecting, based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements; mapping the selected base sequence onto the selected set of frequency domain resource elements; and transmitting the selected and frequency mapped base sequence via an OFDM symbol.

### TECHNICAL FIELD

This description relates to wireless communications.

### BACKGROUND

A communication system may be a facility that enables communication between two or more nodes or devices, such as fixed or mobile communication devices. Signals can be carried on wired or wireless carriers.

An example of a cellular communication system is an architecture that is being standardized by the 3rd Generation Partnership Project (3GPP). A recent development in this field is often referred to as the long-term evolution (LTE) of the Universal Mobile Telecommunications System (UMTS) radio-access technology. E-UTRA (evolved UMTS Terrestrial Radio Access) is the air interface of 3GPP's Long Term Evolution (LTE) upgrade path for mobile networks. In LTE, base stations or access points (APs), which are referred to as enhanced Node AP (eNBs), provide wireless access within a coverage area or cell. In LTE, mobile devices, or mobile stations are referred to as user equipments (UE). LTE has included a number of improvements or developments. Aspects of LTE are also continuing to improve.

5G New Radio (NR) development is part of a continued mobile broadband evolution process to meet the requirements of 5G, similar to earlier evolution of 3G & 4G wireless networks. In addition, 5G is also targeted at the new emerging use cases in addition to mobile broadband. A goal of 5G is to provide significant improvement in wireless performance, which may include new levels of data rate, latency, reliability, and security. 5G NR may also scale to efficiently connect the massive Internet of Things (IoT) and may offer new types of mission-critical services. For example, ultra-reliable and low-latency communications (URLLC) devices may require high reliability and very low latency.

### SUMMARY

According to an example embodiment, a method may include: performing channel encoding on a plurality of information bits to obtain a codeword that includes a plurality of code bits; segmenting the codeword into a plurality of segments of code bits, wherein each segment of code bits includes a subset of code bits of the codeword; communicating a signal for each of the plurality of segments of code bits of the codeword based on a set of channel resources selected for each segment of code bits, including performing the following for each of the plurality of segments of code bits of the codeword: selecting, based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements; mapping the selected base sequence onto the selected set of frequency domain resource elements; and transmitting the selected and frequency mapped base sequence via an orthogonal frequency division multiplexing (OFDM) symbol.

According to an example embodiment, a method may include configuring a plurality of sets of channel resources, wherein each of the sets of channel resources includes a unique combination of channel resources including one or more of a selected base sequence, a cyclic shift and a selected set of frequency domain resource elements; receiving a plurality of signals via orthogonal frequency division multiplexing (OFDM) symbols, wherein each signal of the plurality of signals is associated with a unique combination of channel resources including one or more of a selected base sequence, a cyclic shift and a selected set of frequency domain resource elements; for each received signal and for each of the sets of channel resources, correlating the received signal on the set of frequency domain resource elements with the base sequence of the set of channel resources; associating an output of the correlating with a block of code bit values that is associated with a set of the channel resources, wherein each block of code bit values forms a segment of a codeword among a set of codewords, wherein each codeword corresponds to a plurality of information bits via channel encoding; and detecting a plurality of information bits based on outputs of the correlating, for the received plurality of signals.

Other example embodiments are provided or described for each of the example methods, including: means for performing any of the example methods; a non-transitory computer-readable storage medium comprising instructions stored thereon that, when executed by at least one processor, are configured to cause a computing system to perform any of the example methods; and an apparatus including at least one processor, and at least one memory including computer program code, the at least one memory and the computer program code configured to, with the at least one processor, cause the apparatus at least to perform any of the example methods.

The details of one or more examples of embodiments are set forth in the accompanying drawings and the description below. Other features will be apparent from the description and drawings, and from the claims.

### BRIEF DESCRIPTION OF THE DRAWINGS

FIG. 1 is a block diagram of a wireless network according to an example embodiment.

FIG. 2 is a diagram illustrating a number of required resource blocks for different payloads or different number of transmission bits.

FIGS. 3A and 3B are diagrams illustrating signal processing performed by a wireless transmitter (e.g., by a UE for uplink transmission) according to an example embodiment.

FIG. 4 is a signalling diagram illustrating operation of a system, such as operation of a UE (or user device) and a gNB (or other network node) according to an example embodiment.

FIG. 5 is a flow chart illustrating operation of a transmitting node (e.g., a UE) according to an example embodiment.

FIG. 6 is a flow chart illustrating operation of a receiving node (e.g., a gNB or other network node) according to an example embodiment.

FIG. 7 is a diagram illustrating some example resource sets selected for PUCCH format 0 and PUCCH format 1, according to an example embodiment.

FIG. 8 is a block diagram of a wireless station or node (e.g., network node, user node or UE, relay node, or other node).

### DETAILED DESCRIPTION

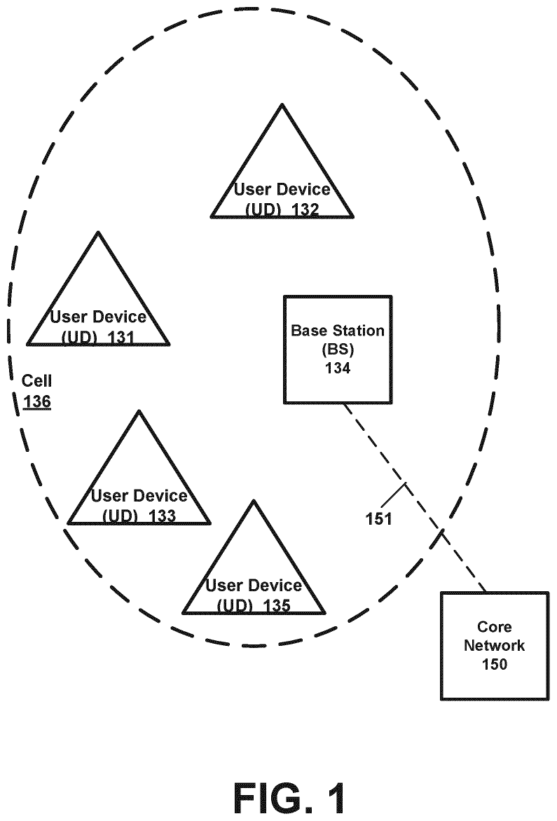

FIG. 1 is a block diagram of a wireless network 130 according to an example embodiment. In the wireless network 130 of FIG. 1, user devices 131, 132, 133 and 135, which may also be referred to as mobile stations (MSs) or user equipment (UEs), may be connected (and in communication) with a base station (BS) 134, which may also be referred to as an access point (AP), an enhanced Node B (eNB), a gNB or a network node. The terms user device and user equipment (UE) may be used interchangeably. A BS may also include or may be referred to as a RAN (radio access network) node, and may include a portion of a BS or a portion of a RAN node, such as (e.g., such as a centralized unit (CU) and/or a distributed unit (DU) in the case of a split BS or split gNB). At least part of the functionalities of a BS (e.g., access point (AP), base station (BS) or (e) Node B (eNB), gNB, RAN node) may also be carried out by any node, server or host which may be operably coupled to a transceiver, such as a remote radio head. BS (or AP) 134 provides wireless coverage within a cell 136, including to user devices (or UEs) 131, 132, 133 and 135. Although only four user devices (or UEs) are shown as being connected or attached to BS 134, any number of user devices may be provided. BS 134 is also connected to a core network 150 via a S1 interface 151. This is merely one simple example of a wireless network, and others may be used.

A base station (e.g., such as BS 134) is an example of a radio access network (RAN) node within a wireless network. A BS (or a RAN node) may be or may include (or may alternatively be referred to as), e.g., an access point (AP), a gNB, an eNB, or portion thereof (such as a/centralized unit (CU) and/or a distributed unit (DU) in the case of a split BS or split gNB), or other network node.

According to an illustrative example, a BS node (e.g., BS, eNB, gNB, CU/DU, . . . ) or a radio access network (RAN) may be part of a mobile telecommunication system. A RAN (radio access network) may include one or more BSs or RAN nodes that implement a radio access technology, e.g., to allow one or more UEs to have access to a network or core network. Thus, for example, the RAN (RAN nodes, such as BSs or gNBs) may reside between one or more user devices or UEs and a core network. According to an example embodiment, each RAN node (e.g., BS, eNB, gNB, CU/DU, . . . ) or BS may provide one or more wireless communication services for one or more UEs or user devices, e.g., to allow the UEs to have wireless access to a network, via the RAN node. Each RAN node or BS may perform or provide wireless communication services, e.g., such as allowing UEs or user devices to establish a wireless connection to the RAN node, and sending data to and/or receiving data from one or more of the UEs. For example, after establishing a connection to a UE, a RAN node or network node (e.g., BS, eNB, gNB, CU/DU, . . . ) may forward data to the UE that is received from a network or the core network, and/or forward data received from the UE to the network or core network. RAN nodes or network nodes (e.g., BS, eNB, gNB, CU/DU, . . . ) may perform a wide variety of other wireless functions or services, e.g., such as broadcasting control information (e.g., such as system information or on-demand system information) to UEs, paging UEs when there is data to be delivered to the UE, assisting in handover of a UE between cells, scheduling of resources for uplink data transmission from the UE(s) and downlink data transmission to UE(s), sending control information to configure one or more UEs, and the like. These are a few examples of one or more functions that a RAN node or BS may perform.

A user device or user node (user terminal, user equipment (UE), mobile terminal, handheld wireless device, etc.) may refer to a portable computing device that includes wireless mobile communication devices operating either with or without a subscriber identification module (SIM), including, but not limited to, the following types of devices: a mobile station (MS), a mobile phone, a cell phone, a smartphone, a personal digital assistant (PDA), a handset, a device using a wireless modem (alarm or measurement device, etc.), a laptop and/or touch screen computer, a tablet, a phablet, a game console, a notebook, a vehicle, a sensor, and a multimedia device, as examples, or any other wireless device. It should be appreciated that a user device may also be (or may include) a nearly exclusive uplink only device, of which an example is a camera or video camera loading images or video clips to a network. Also, a user node may include a user equipment (UE), a user device, a user terminal, a mobile terminal, a mobile station, a mobile node, a subscriber device, a subscriber node, a subscriber terminal, or other user node. For example, a user node may be used for wireless communications with one or more network nodes (e.g., gNB, eNB, BS, AP, DU, CU/DU) and/or with one or more other user nodes, regardless of the technology or radio access technology (RAT). In LTE (as an illustrative example), core network 150 may be referred to as Evolved Packet Core (EPC), which may include a mobility management entity (MME) which may handle or assist with mobility/handover of user devices between BSs, one or more gateways that may forward data and control signals between the BSs and packet data networks or the Internet, and other control functions or blocks. Other types of wireless networks, such as 5G (which may be referred to as New Radio (NR)) may also include a core network.

In addition, the techniques described herein may be applied to various types of user devices or data service types, or may apply to user devices that may have multiple applications running thereon that may be of different data service types. New Radio (5G) development may support a number of different applications or a number of different data service types, such as for example: machine type communications (MTC), enhanced machine type communication (eMTC), Internet of Things (IoT), and/or narrowband IoT user devices, enhanced mobile broadband (eMBB), and ultra-reliable and low-latency communications (URLLC). Many of these new 5G (NR)-related applications may require generally higher performance than previous wireless networks.

IoT may refer to an ever-growing group of objects that may have Internet or network connectivity, so that these objects may send information to and receive information from other network devices. For example, many sensor type applications or devices may monitor a physical condition or a status, and may send a report to a server or other network device, e.g., when an event occurs. Machine Type Communications (MTC, or Machine to Machine communications) may, for example, be characterized by fully automatic data generation, exchange, processing and actuation among intelligent machines, with or without intervention of humans. Enhanced mobile broadband (eMBB) may support much higher data rates than currently available in LTE.

Ultra-reliable and low-latency communications (URLLC) is a new data service type, or new usage scenario, which may be supported for New Radio (5G) systems. This enables emerging new applications and services, such as industrial automations, autonomous driving, vehicular safety, e-health services, and so on. 3GPP targets in providing connectivity with reliability corresponding to block error rate (BLER) of 10⁻⁵ and up to 1 ms U-Plane (user/data plane) latency, by way of illustrative example. Thus, for example, URLLC user devices/UEs may require a significantly lower block error rate than other types of user devices/UEs as well as low latency (with or without requirement for simultaneous high reliability). Thus, for example, a URLLC UE (or URLLC application on a UE) may require much shorter latency, as compared to a eMBB UE (or an eMBB application running on a UE).

The techniques described herein may be applied to a wide variety of wireless technologies or wireless networks, such as LTE, LTE-A, 5G (New Radio (NR)), cmWave, and/or mmWave band networks, IoT, MTC, eMTC, eMBB, URLLC, etc., or any other wireless network or wireless technology. These example networks, technologies or data service types are provided only as illustrative examples.

Uplink control information may be transmitted by a UE to a gNB or other network node via a physical uplink control channel (PUCCH), for example, or other uplink control channel. Rel-15 NR (release 15 of New Radio) supports four PUCCH formats. Those can be categorized by PUCCH duration, supported payload, as well as by multiplexing capability: PUCCH formats 0 & 1 support UCI payload of 1 or 2-bits, while PUCCH formats 2, 3, and 4 support larger UCI payloads; PUCCH formats 0 & 2 have a duration of 1 or 2 symbols and are occasionally referred to as short PUCCH formats. PUCCH formats 1, 3, and 4 can have a duration of 4 to 14 symbols, and may be referred to as long PUCCH formats; PUCCH formats 0 & 1 support multiplexing of several UEs on the same RB (resource block) via cyclic shifts of sequence and in case of PUCCH format 1, also via OCC (orthogonal cover code), that is, DFT (Discrete Fourier Transform) block spreading over DFT Spread Orthogonal Frequency Domain Multiplexing (DFT-S-OFDM) symbols. PUCCH format 4 supports also UE multiplexing via block spreading within each DFT-S-OFDM symbol. PUCCH formats 2 & 3 support single UE on RBs allocated for the PUCCH resource. Single PUCCH resource of format 2 or 3 can occupy 1-16 RBs, according to an illustrative example. Also, for example, a resource block (RB) may include a set of subcarriers or frequency domain resources for a time period or for one or more symbols.

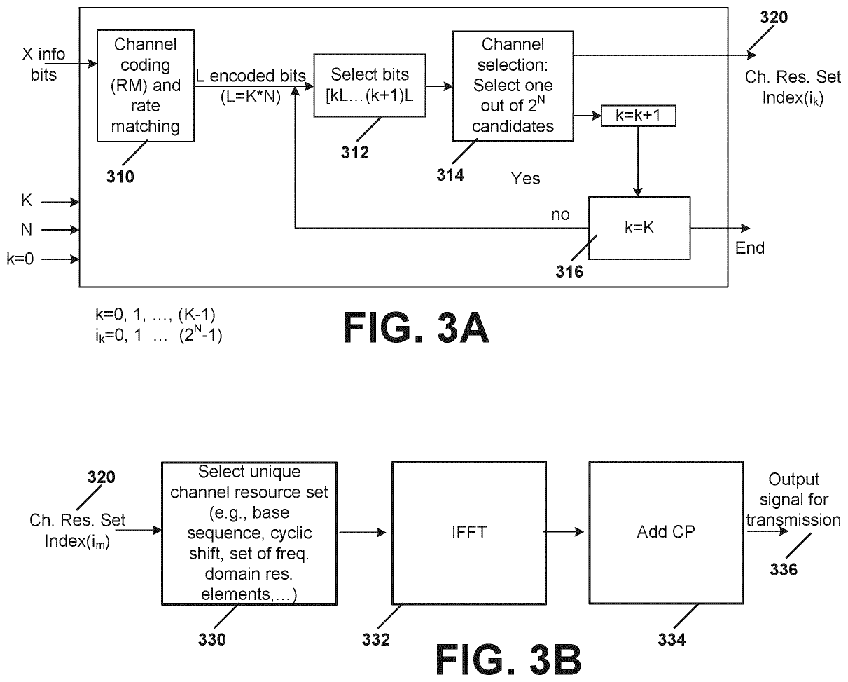

Although example embodiment are described from PUCCH point of view, the examples or example embodiments described are applicable to other scenarios as well, such as, for example, when transmitting small PUSCH (e.g., data via physical uplink shared channel) packets. In an embodiment, the solutions or example embodiments may be used also for larger PUSCH packets, e.g., where each larger packet is segmented into multiple smaller parts, each transmitted separately (e.g., according to example operations shown in FIG. 3A).

Yet another way to categorize the PUCCH formats is via the used signalling method: PUCCH formats 1, 2, 3 and 4 use coherent communication and have some resources reserved for DMRS facilitating channel estimation at the receiver. For coherent demodulation (or coherent communication), a transmitter or transmitting device may transmit (in addition to transmitting data or control information) a reference signal (e.g., such as to provide a phase reference) to allow the receiver to more reliably or more accurately perform demodulation. With some types of DMRS-based coherent transmission, uplink control information (UCI) may be encoded using channel coding and modulated, and then multiplexed with a demodulation reference signal (DMRS) before transmission. At the receiver side, the receiver may first perform a channel estimation using the received DMRS signal, then coherently demodulate the encoded UCI payload or signal using the estimated channel, and decoded. Other types of coherent communication may be used as well. For example, other receiver strategies or receiver architectures may be used or applied as well. In some examples, a DMRS may not always be present or used. In case of PUCCH format 2, data and pilot resources are multiplexed in frequency while in case of PUCCH formats 1, 3, and 4, data and pilot resources are multiplexed in time in different DFT-S-OFDM symbols. However, PUCCH format 0 uses different signalling method: UE selects a cyclic shift of a sequence based on the conveyed information content. This may be referred to as sequence selection.

Furthermore, it may be desirable to increase cell coverage or range (e.g., to allow a gNB to communicate with UEs that are located at a cell edge or further away from the gNB or network node for wireless and/or cellular communications, such as for New Radio (NR or 5G) communications. In some cases, signals transmitted by UEs at an edge of a cell may have relatively low signal-to-noise ratio (SNR) when received by the gNB or network node. As noted, it may be desirable to provide an increased range to allow communications and/or higher data rate communications between a gNB and UEs that may be at a cell edge or which may have a relatively low SNR when their transmitted signal is received by the gNB. While DMRS (demodulation reference signal) based coherent communication is efficient at medium or high SNR, it is may not be optimal at low SNR, at least in some cases. Coherent communication performance at low SNR suffers from one or more drawbacks, such as for example: part of transmission energy and resources are used for DMRS facilitating coherent demodulation, but do not convey signaled information; and/or channel estimation quality is typically low (or relatively low) leading to considerable channel estimation loss in demodulation and decoding.

Correspondingly, at least in some cases, DMRS-less PUCCH formats may be considered as coverage enhancements for UCI payloads above 2-bits. It may be desirable to provide a communication system where: A channel for transmission of uplink control information (e.g., such as physical uplink control channel (PUCCH) or other uplink control channel) should be a robust channel detected reliably also from the cell edge (e.g., which may have relatively low SNR for received signals); and/or it is desirable to increase the uplink control information (e.g., PUCCH) payload that can be reliably signaled from the cell edge (e.g., by UEs to the gNB).

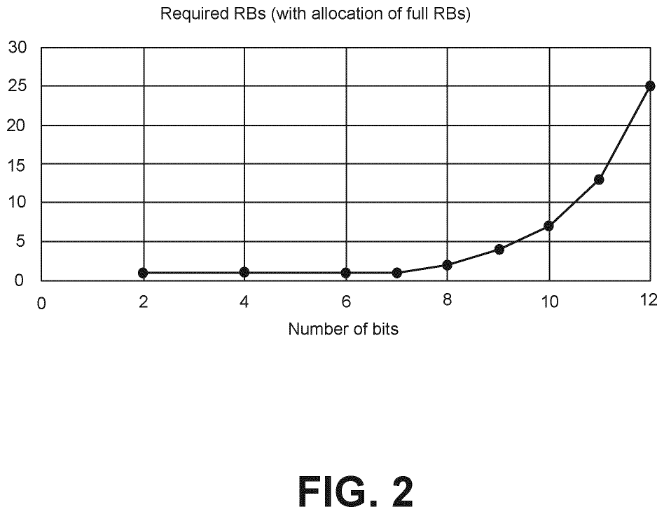

In some cases, a single sequence (e.g., out of large set of orthogonal sequences, for example), representing a relatively large number of bits (e.g., such as a sequence representing a relatively large block of bits or a codeword), may be transmitted based on information content to be conveyed. FIG. 2 is a diagram illustrating a number of required resource blocks for different payloads or different number of transmission bits. As shown by FIG. 2, for such sequence transmission, providing such a large data capacity sequence may be require a very large number of time-frequency resources or resource blocks, because the number of resource blocks (RBs) (or amount of time-frequency resources) required for sequence selection signalling with orthogonal sequences may typically increase rapidly as the number of transmitted bits (or payload) increases (see FIG. 2). For example, to transmit a long sequence, via multiple OFDM symbols (e.g., via 14 OFDM symbols in some illustrative examples described herein), representing 12-bits, 25 PRBs may be required to transmit such longer sequence.

Therefore, example embodiments are described that may allow transmission of higher payloads for uplink control information, while limiting the amount of required PRBs, and also while avoiding DMRS coherent demodulation (which is inefficient for low SNR cases, such as UEs located at a cell edge). According to an example embodiment, a codeword of encoded bits may be segmented into a set or plurality of segments, and then for each segment: a set of unique channel resources is selected among a plurality of sets of channel resources (e.g., a unique set of channel resources including a base sequence, a cyclic shift and/or a set of frequency domain resource elements) based on the content of the segment. A signal based on the set of unique channel resources is transmitted via an OFDM symbol. This process (selecting a unique set of channel resources and transmitting a sequence based on the selected set of channel resources via an OFDM symbol) may be repeated for each segment of the codeword, in order to communicate information (a plurality of shorter sequences) that represents the entire codeword, without using a large number of PRBs (e.g., since a smaller set of unique channel resources is required) and/or without using DMRS coherent demodulation (in this case, the sequence transmission is non-coherent communication, since no DMRS signal is transmitted with the sequences). Further examples, details and/or illustrative example embodiments are described hereinbelow.

FIGS. 3A and 3B are diagrams illustrating signal processing performed by a wireless transmitter (e.g., by a UE for uplink transmission) according to an example embodiment. Referring to FIG. 3A, X information bits may be received by a transmitting node or UE (e.g., data or information bits for transmission may be received from an upper layer of the UE) for uplink (UL) transmission. At 310, channel coding (or channel encoding) may be performed, such as Reed Muller coding, on the X information bits to generate L encoded bits. Also, at 310, rate matching may be performed. Channel coding (also known as channel encoding, such as Reed Muller coding) may introduce redundancy for the information bits, and allow error detection and/or correct at the receiver (or receiving node). Thus, after channel encoding and possibly rate matching, X=10 information bits may become L=28 encoded bits (a codeword), as an illustrative example. Thus, a codeword of L=28 bits may result after channel encoding (and possibly rate matching). Rather than selecting one unique sequence (for transmission) for all 28 code bits (which would require a very large number of sequences and a very large number of resource blocks, per FIG. 2), the codeword (e.g., L=28 bits in this example) may be segmented at block 312 into K segments of N code bits, wherein each segment of code bits includes a subset of code bits of the codeword. As an illustrative example, K may be 14 segments (e.g., segmenting the codeword into 14 segments), where each segment includes 2-bits (a 2-bit segment) of the 28 bit codeword. Thus, for example, at block 312, a segment of N bits (e.g., N=2-bits) is selected from the L bit codeword (for k=1 . . . . K).

Channel coding may offer several advantages. For example, without channel coding (also referred to as channel encoding), codewords for different information bits may result in selecting the same sets of unique channel resources for all segments except for one segment. When channel coding is applied, different sets of unique channel resources are selected for multiple segments.

Several steps or blocks in FIGS. 3A and 3B (e.g., including blocks 314, 316, 320, 330, 332 and 334) may be performed (or repeated) for each segment of code bits (for each segment of the codeword output by block 310). The variable k (e.g., a segment index) may incremented each time from k=1 to k=K, through the process, in order to obtain (select) and process each next segment of the codeword, to allow a sequence to be transmitted via an OFDM symbol for each segment, according to an illustrative example embodiment. This process (via blocks 312, 314, 316, 320, 330, 332 and 334) may be repeated for each segment, until all segments of the codeword have been processed (until k=K), and a signal is transmitted for each segment via an OFDM symbol, for example.

With respect to the example of FIG. 3A:

### Input Parameters:

X information bits (e.g., 10 UCI (uplink control information) bits to be transmitted); X may, for example, vary from transmission to transmission, e.g., based on the number of HARQ-ACK bits to be multiplexed, and/or based on the CSI (channel state information) content. Also, when transmitting the PUCCH (uplink control channel information), the UE knows or derives the number of UCI (uplink control information) bits based on the signalling received and/or based on other information (such as timing information);

K=number of symbols with unique channel selection, or number of segments (e.g., K=14 segments of the codeword, or K=14 OFDM symbols with a unique channel resource set selection); K may, for example, be indicated via higher layer signalling. It can be determined also based on other signalling, such as time domain resource allocation.

N=number of indicated bits per symbol (or number of bits per segment of the codeword). This depends on the number of available channels/symbol (I) as N=floor (log 2(I)); In an example embodiment, each of the 14 symbols (or 14 segments) may include 2-bits, where a signal (e.g., sequence) is transmitted via an OFDM symbol for each of the 14 segments, as shown in FIG. 3B; For example, N can be indicated via higher layer signalling. It can be determined also based on the number of available channels/symbols. The available channels/symbol can be indicated via higher layer signalling, or may be determined based on implicit signalling. An example of such is determining PUCCH resources based on a control channel element used for transmitting PDCCH (physical downlink control channel).

k=0 (symbol index value, or segment index value), where k is initialized to zero, and incremented for each segment, as shown in FIG. 3A, so as to loop through or repeat the selection of the next segment of code bits (select bits block 312), and determination or selection of a channel resource set index at 320 and/or selection of a unique set of channel resources for each segment;

### Output Parameters:

iₖ=channel resource set (or sequence) index for the kth symbol (0, . . . , (2N−1);
   Coding rate: X/(K*N).

Further details of operations at 314, 316, 320, 330, 332 and 334 will be briefly described, as an illustrative example embodiment. At block 314, a unique set of channel resources is selected for a segment based on the code bit values of the segment, wherein each set of channel resources is selected among a plurality of sets of channel resources. For example, each of the sets of channel resources may include a unique combination of channel resources including one or more of a selected base sequence, a cyclic shift and a selected set of frequency domain resource elements, other channel resources may be used as well. Different combinations of channel resources may be configured and used to provide a plurality of unique sets of channel resources, e.g., including a unique set of channel resources for each of the different bit values (e.g., 00, 01, 10, 11) for each segment. For a 2-bit segment, there are 4 possible unique sets of channel resources. For example, in the case where each segment is 2 code bits, there will be 4 unique sets of channel resources. For example, a base sequence may be used along with 4 different cyclic shifts of that base sequence, to obtain 4 different sets of channel resources; or, 4 different base sequences; or a base sequence and 4 different sets of frequency domain resource elements (e.g., sets of subcarriers, frequencies or other frequency domain resource elements).

Table 1 below shows an example of channel resources where 4 different combinations of 2 base sequences and 2 cyclic shifts are used to provide 4 unique sets of channel resources for different values of segments (e.g., 2-bit segments) of code bits (of a codeword). Each set of channel resources has an associated channel resource set index. A base sequence BS0 and cyclic shift CS0 is used for a for a codeword segment having bit values of 00 (associated with channel resource set index 0); a base sequence BS0 and cyclic shift CS1 is used for a codeword segment having bit values of 01 (associated with channel resource set index 1); a base sequence BS1 and cyclic shift CS0 is used for a codeword segment having bit values of 10 (associated with channel resource set index 2); and, a base sequence BS1 and cyclic shift CS1 is used for a codeword segment having bit values of 11 (associated with channel resource set index 3). Each channel resource set index may identify or indicate the associated set of channel resources.

TABLE 1
A first example of sets of channel resources.

| Channel resource | Segment of | Base | Cyclic |
|---|---|---|---|
| set index | code bits | sequence | shift |
| 0 | 00 | BS0 | CS0 |
| 1 | 01 | BS0 | CS1 |
| 2 | 10 | BS1 | CS0 |
| 3 | 11 | BS1 | CS1 |

Table 2 (below) illustrates another example of 4 different sets of channel resources where a base sequence BS0 and four different sets of frequency domain resource elements are used to provide 4 different (or unique) sets of channel resources. For example, base sequence BS0 and frequency domain resource element (FDRE) set 0 are used for a codeword segment having bit values of 00 (associated with, or identified by, channel resource set index 0); base sequence BS0 and frequency domain resource element set 1 are used for a codeword segment having bit values of 01 (associated with channel resource set index 1); base sequence BS0 and frequency domain resource element set 2 are used for a codeword segment having bit values of 10 (associated with channel resource set index 2); and, base sequence BS0 and frequency domain resource element set 3 are used for a codeword segment having bit values of 11 (associated with channel resource set index 3).

TABLE 2
A second example of sets of channel resources.

| Channel resource | Segment of | Base | Freq. domain |
|---|---|---|---|
| set index | code bits | sequence | resource elements |
| 0 | 00 | BS0 | FDRE set 0 |
| 1 | 01 | BS0 | FDRE set 1 |
| 2 | 10 | BS0 | FDRE set 2 |
| 3 | 11 | BS0 | FDRE set 3 |

These are just a few illustrative examples of segments (other sizes of segments may be used) and examples of unique (or orthogonal) sets of channel resources. Other or different combinations of sets of channel resources may be used. For example, each set of channel resources may include an orthogonal or unique selection of at least one of: a base sequence selection, and a cyclic shift selection; a base sequence selection and a selected set of frequency domain resource elements or subcarriers; a cyclic shift selection; a cyclic shift selection and a physical resource block selection that includes adjacent physical resource blocks; a cyclic shift selection and a physical resource block selection that includes frequency hopping or non-adjacent physical resource blocks; a cyclic shift selection, a base sequence selection, and a frequency hopping physical resource block selection that uses non-adjacent physical resource blocks; a cyclic shift selection, and a comb (where a comb may include interleaved subcarrier selection or interleaved frequency domain resource elements); or a cyclic shift selection, a comb or interleaved subcarrier selection, and a physical resource block selection that includes frequency hopping (which may include use of non-adjacent resource blocks or non-adjacent frequency domain resource elements, over time).

Referring to FIG. 3A again, for each segment of the codeword, channel selection block 314 may output at 320 a channel resource set index iₖ (e.g., iₖ=0, 1, 2 or 3) to identify one of the unique sets of channel resources that have been selected for the segment (e.g., based on code bit values of the segment), such as shown, for example, in the examples of Tables 1-2. With reference to FIG. 3A, the segment counter (k) (which may also be referred to as the symbol counter, since a signal for each segment may be transmitted via an OFDM symbol) may then be incremented to indicate the next segment of code bits of the codeword (and/or to indicate the next symbol). At 316 of FIG. 3A, the segment counter is compared to the number of segments (K), to determine if this process has been completed for all segments (e.g., for all K segments of the codeword, e.g., for all 14 segments of a 28 bit codeword as an example). If there are more segments of the codeword to be processed, then the flow returns to block 312 to select the bits (within the codeword) of the next segment.

As shown in FIG. 3B, the operations at blocks 330, 332 and 334 are repeated for each segment (e.g., for each channel resource set index output at 320 from channel selection block 314). At block 330, a unique channel resource set is selected or determined based on the received channel resource set index. For example, each of the sets of channel resources may include a unique combination of channel resources including, e.g., one or more of a selected base sequence, a cyclic shift and a selected set of frequency domain resource elements, and/or other channel resources. For example, if the sets of channel resources of Table 1 (as an example) have been configured (e.g., if the UE has received control information, broadcast control information, or a control message indicating such sets of channel resources, or has been pre-configured to use such sets of channel resources shown in Table 1, as an example), and the channel resource set index via line 320 indicates a channel resource set index iₖ=2 (associated with segment code bit values of 10), then block 330 would select the unique channel resource set associated with the channel resource set index iₖ=2, which would include channel resources that include (by way of illustrative example) a base sequence of BS1 and a cyclic shift of CS0 (as shown in the example of Table 1). Thus, at 330, a unique channel resource set (e.g., which may include a selected base sequence, a selected cyclic shift, a selected set of frequency domain resource elements, and/or other selected channel resource(s)) may be selected based on the channel resource set index.

After the channel resource set has been selected at 330 for a segment based on the channel resource set index, the selected base sequence (e.g., which may be cyclically shifted, depending on the set of channel resources that are selected) may be mapped onto a selected set of frequency domain resource elements (e.g., subcarriers, sets of subcarriers or other frequency domain resource elements). The selected and frequency mapped base sequence (which may or may not have been cyclically shifted) may then be transmitted via a symbol, such as via an orthogonal frequency division multiplexing (OFDM) symbol. The transmitting may include, for example, performing an inverse Fast Fourier Transform operation at block 332 on the selected and frequency mapped base sequence, and inserting a cyclic prefix (CP) at block 334 to generate an output signal 336 for transmission. The output signal 336 may then be transmitted by the UE or other transmitting node via a symbol, such as via an OFDM symbol. For example, according to FIG. 3A, the UE may perform processes shown in FIG. 3B K times in a row to transmit PUCCH with K OFDM/DFT-s-OFMD symbols.

Thus, according to an example embodiment, instead of transmitting one long sequence for a codeword, a combination of channel encoding (e.g., Reed Muller coding), codeword segmentation and channel resource set selection is performed for each of a plurality of segments of the codeword, in order to increase signalling payload capacity, without requiring a significant increase in time-frequency resources (or PRBs) for transmission of the sequences or signals or requiring coherent communications. The channel encoding (e.g., Reed Muller coding) is performed to introduce redundancy and provide a codeword (of encoded bits). The codeword may be segmented into K segments of N bits each, and a set of unique channel resources are selected for each segment. A signal (e.g., a sequence) is transmitted based on the unique channel resource set selected for each segment. In this manner, shorter sequences (e.g., signals generated based on a selected set of channel resources based on a segment of a codeword) may be used to transmit each sequence, and this process may be looped or repeated (as shown in FIG. 3A) in order to transmit a signal or sequence for each of the segments, until a signal has been transmitted for all segments of the codeword. In this manner, the codeword may be communicated by the transmitting node (e.g., UE) to a receiving node (e.g., a gNB).

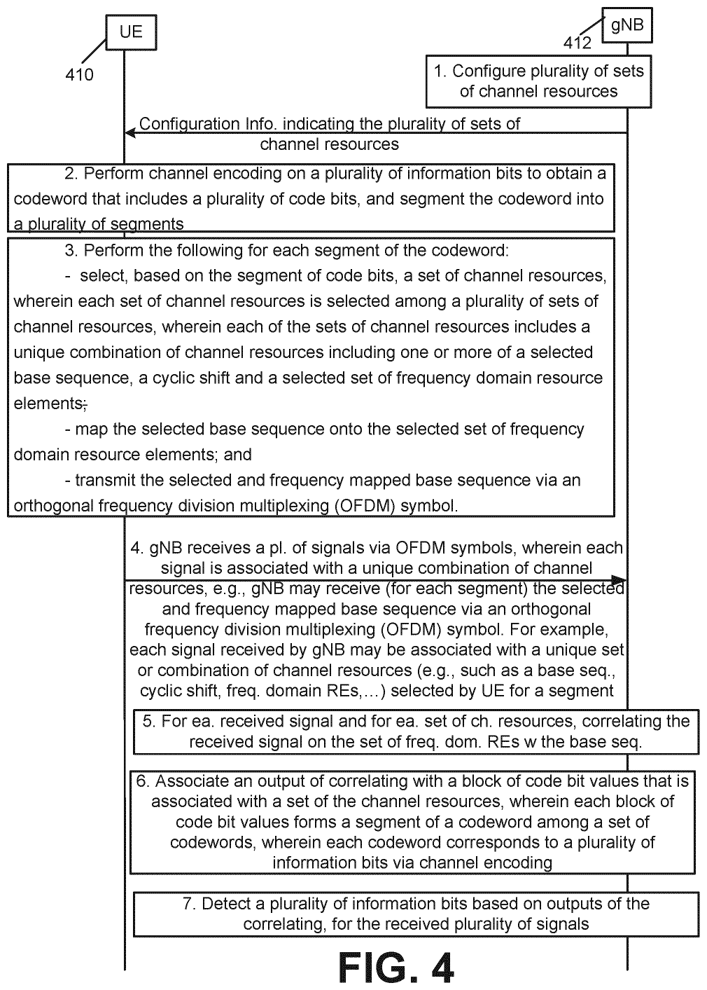

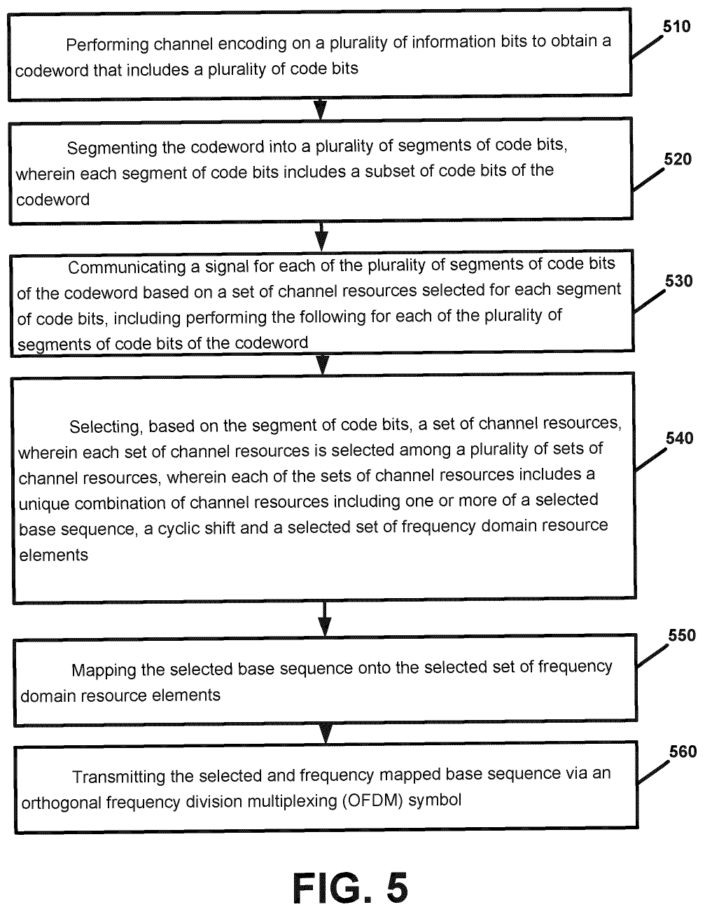

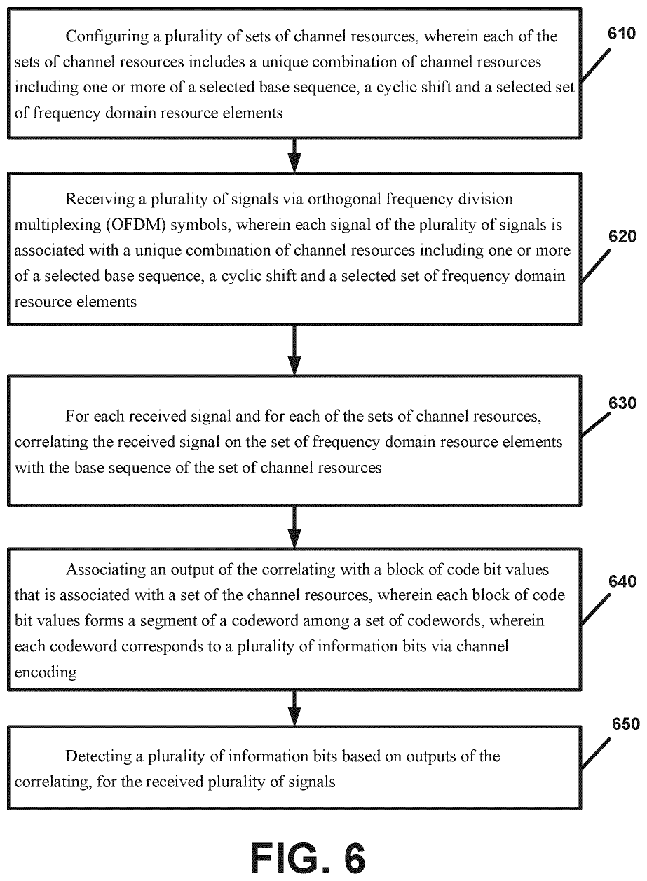

FIG. 4 is a signalling diagram illustrating operation of a system, such as operation of a UE (or user device) and a gNB (or other network node) according to an example embodiment. FIG. 5 is a flow chart illustrating operation of a transmitting node (e.g., a UE) according to an example embodiment. FIG. 6 is a flow chart illustrating operation of a receiving node (e.g., a gNB or other network node) according to an example embodiment.

A UE (or transmitting node) 410 and a gNB (or a receiving node) 412 are shown in FIG. 4. With reference to the signalling diagram of FIG. 4 and the flow charts of FIGS. 5-6, at operation 1 of FIG. 4 and operation 610 of FIG. 6, the gNB 412 may configure a plurality of sets of channel resources. Each of the sets of channel resources may include a unique combination of channel resources including one or more of a selected base sequence, a cyclic shift and a selected set of frequency domain resource elements. The gNB 412 may inform the UE 410 of the configured sets of channel resources, e.g., by broadcasting such configuration information, and/or by sending the configuration information via a message to the UE 410. Or, UE 410 may be pre-configured with such information of the configured plurality of sets of channel resources.

At operation 2 of FIG. 4 and operation 510 of FIG. 5, the UE performs channel encoding (e.g., see block 310 of FIG. 3, operation 510, FIG. 5) on a plurality of information bits to obtain a codeword that includes a plurality of code bits, and segments (operation 520, FIG. 5, and block 312, FIG. 3) the codeword into a plurality of segments. For example, channel encoding (and possibly rate matching) may be performed on X=10 information bits to obtain a codeword of L=28 code bits (or 28 encoded bits). Thus, for example, a codeword of 28 code bits may be segmented into K=14 segments of 2 code bits per segment. See FIG. 3A as an illustrative example.

Operation 3 of FIG. 4 will now be described, which may include or may correspond roughly to operations 530, 540, 550 and/or 560 of FIG. 5. At operation 530 of FIG. 5, the UE or transmitting device may communicate a signal for each of the plurality of segments of code bit of the codeword based on a set of channel resources selected for each segment of code bits, which may include performing the operations of operation 3 of FIG. 4 and operations 540, 550 and 560 of FIG. 5, as described below.

Operation 540 of FIG. 5 may include selecting, based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements (e.g., this may include, for example, determining (e.g., by channel selection block 314, FIG. 3A) a channel resource set index (320, FIG. 3A), and then selecting (by block 330 of FIG. 3B) a unique channel resource set, based on the channel resource set index, for each of the segments of the codeword. As noted, the selected channel resource set for a segment may include, for example, a selected base sequence, a cyclic shift, and/or a set of frequency domain resource elements (e.g., a set of subcarriers or other frequency domain resource elements), and/or other channel resources.

Operation 550 may include mapping the selected base sequence onto the selected set of frequency domain resource elements.

Operation 560 includes transmitting the selected and frequency mapped base sequence via an orthogonal frequency division multiplexing (OFDM) symbol.

According to an example embodiment, the transmitting (operation 560, FIG. 5) may include transmitting, as part of a physical uplink control channel (PUCCH) transmission without transmitting a demodulation reference signal, the selected and frequency mapped base sequence via at least one of an orthogonal frequency division multiplexing (OFDM) symbol or a Discrete Fourier Transform-Spread OFDM (DFT-s-OFDM) symbol.

The method of FIG. 5 may further include performing the following for each of the plurality of segments of code bits of the codeword: performing a selected cyclic shift on the selected base sequence, based on the selected set of channel resources for the segment of code bits.

In an example embodiment of FIG. 5, the transmitting (operation 560) may include: performing an Inverse Fast Fourier Transform (IFFT) operation on the selected and frequency mapped base sequence; inserting a cyclic prefix (CP) to generate an output signal; and transmitting the output signal output.

With respect to the diagram of FIG. 4 and methods of FIGS. 5-6, each set of channel resources may include an orthogonal or unique selection of at least one of (by way of illustrative examples): a base sequence selection, and a cyclic shift selection; a base sequence selection and a selected set of frequency domain resource elements or subcarriers; a cyclic shift selection; a cyclic shift selection and a physical resource block selection that includes adjacent physical resource blocks; a cyclic shift selection and a physical resource block selection that includes frequency hopping or non-adjacent physical resource blocks; a cyclic shift selection, a base sequence selection, and a frequency hopping physical resource block selection that uses non-adjacent physical resource blocks; a cyclic shift selection, and a comb or interleaved subcarrier selection; or a cyclic shift selection, a comb or interleaved subcarrier selection, and a physical resource block selection that includes frequency hopping or non-adjacent physical resource blocks.

With respect to the method of FIG. 5 and diagram of FIG. 4, the selecting (e.g., operation 540), based on the segment of code bits, a set of channel resources, may include: determining, based on the segment of code bits, a channel resource set index for the segment of code bits; and wherein the transmitting comprises transmitting a signal based on a set of channel resources associated with the channel resource set index, and via either one orthogonal frequency division multiplex (OFDM) symbol or one Discrete Fourier Transform-Spread OFDM (DFT-s-OFDM) symbol.

Also, with respect to the diagram of FIG. 4 and methods of FIGS. 5-6: a number of the segments of the codeword is equal to a number of (DFT-s-)OFDM symbols per transmission (K); the number of bits per segment equals to N; and the number of bits in the codeword is K*N.

Operations 4-7 of FIG. 4 and FIG. 6 describe some example operations of a receiving node, such as a gNB 412. As noted above, at operation 1 of FIG. 4 and operation 610 of FIG. 6, the gNB 412 may configure a plurality of sets of channel resources, wherein each of the sets of channel resources may include a unique combination of channel resources including one or more of a selected base sequence, a cyclic shift and a selected set of frequency domain resource elements.

At operation 4 of FIG. 4 and operation 620 of FIG. 6, the gNB 412 may receive a plurality of signals via orthogonal frequency division multiplexing (OFDM) symbols, wherein each signal of the plurality of signals is associated with a unique combination of channel resources including one or more of a selected base sequence, a cyclic shift and a selected set of frequency domain resource elements, and/or other channel resources. For example, gNB 412 may receive (for each segment) the selected and frequency mapped base sequence via an orthogonal frequency division multiplexing (OFDM) symbol. For example, each signal received by gNB 412 may be associated with a unique set or combination of channel resources (e.g., such as a selected base seq., cyclic shift, freq. domain REs, . . . ) selected by UE for a segment.

At operation 5 of FIG. 4 and operation 630 of FIG. 6, the gNB 412 may, for each received signal and for each of the sets of channel resources, correlate (or perform correlation of) the received signal on the set of frequency domain resource elements with the base sequence of the set of channel resources.

At operation 6 of FIG. 4 and operation 640 of FIG. 6, the gNB 412 may associate an output of the correlating (output of operation 630 of FIG. 6 and operation 5 of FIG. 4) with a block of code bit values that is associated with a set of the channel resources, wherein each block of code bit values forms a segment of a codeword among a set of codewords, wherein each codeword corresponds to a plurality of information bits via channel encoding.

At operation 7 of FIG. 4 and operation 650 of FIG. 6, the gNB 412 may detect a plurality of information bits based on outputs of the correlating, for the received plurality of signals. These detected information bits should be the same X information bits that were input to channel coding block 310 (FIG. 3A) at the transmitting node or UE (assuming no errors).

There may be various ways (or various combinations of resources) to provide/parallel channels/symbol (or to provide different or unique sets of channel resources per segment or per symbol). Various example channel resource options are illustrated in Table 3 below.

Option 1: Cyclic shift (CS) selection;

Option 2: CS selection+frequency hopping (FH) (where frequency hopping may use different frequencies or different subcarriers); In an embodiment, in the case of frequency hopping, the selected channel/sequence resource is (or may be) transmitted twice (i.e., transmitted via two DFT-S-OFDM symbols and via different PRBs, for example.

Option 3: CS+Base sequence selection;

Option 4: CS+Base sequence selection+FH;

Option 5: CS+PRB (physical resources block, including a set of time-frequency resources) selection (adjacent RBs);

Option 6: CS+PRB selection (adjacent RBs)+FH (frequency hopping) (non-adjacent PRBs);

Option 7: CS+comb selection (where a comb selection includes a set of interleaved, or non-adjacent subcarriers or frequency domain resource elements); and/or

Option 8: CS+comb selection+FH. These are merely some illustrative examples of channel resources, and other channel resources and/or other combinations of channel resources may be used. See Table 3 below for an illustration of the options 1-8 described above for different channel resource sets.

TABLE 3
Example options for providing channels or different channel resource sets.

| | PRB | FH | Cyclic shift | Base sequence | Frequency comb | Notes! |
|---|---|---|---|---|---|---|
| Option 1 | m | No | a, b, c, d | x | N/A | Cyclic shift selection |
| Option 2 | m1, m2 | Yes | a, b, c, d | x | N/A | Cyclic shift selection + FH |
| Option 3 | m | No | a, b | x, y | N/A | CS + Base sequence selection |
| Option 4 | m1, m2 | Yes | a, b | x, y | N/A | CS + Base sequence selection + FH |
| Option 5 | m, n | No | a, b | x | N/A | |
| Option 6 | m1, m2, n1, n2 | Yes | a, b | x | N/A | |
| Option 7 | m | No | a, b | x | f1, f2 | |
| Option 8 | m1, m2 | Yes | a, b | x | f1, f2 | |

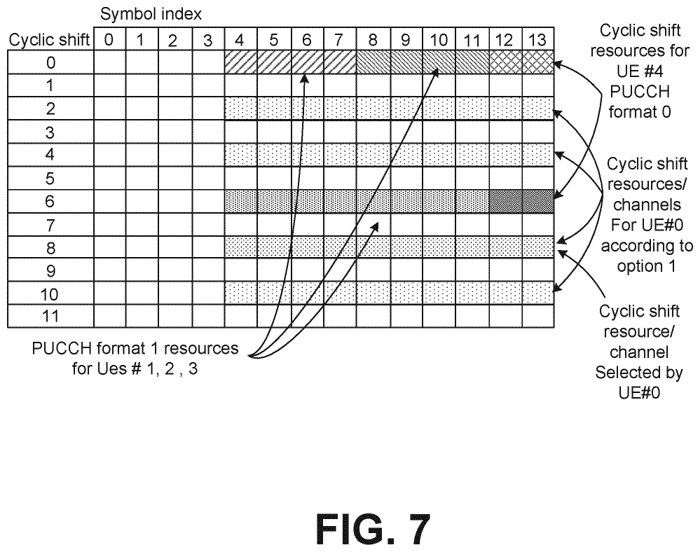

Also, FIG. 7 is a diagram illustrating some example resource sets selected for PUCCH format 0 and PUCCH format 1, according to an example embodiment.

With respect to the illustrative examples shown in Table 3 and FIG. 7, options 1,2,5,6 allow multiplexing of legacy PUCCH format 0 or 1 on the same resources. (Especially if, e.g., 4 cyclic shifts are used per resource block (RB)). In these cases, a base sequence is not used to generate multiple parallel (or multiple unique or orthogonal) sets of channel resources, and cyclic shifts of single base sequence may be used. In that case, the used single base sequence may of course change between symbols according to legacy PUCCH base sequence hopping patterns The multiplexing with legacy PUCCH format 0 and 1 are shown below for Option 1, where PUCCH uses the last 10 symbols of a slot and only every second cyclic shift is used. Such multiplexing is beneficial as it allows for efficient resource usage. Further, gNB can efficiently correlate the received signal with all used cyclic shifts with the same processing steps. For example, a received signal's frequency response is multiplied with complex conjugate of base sequence's frequency response. The result is converted to time with inverse DFT. The inverse DFT (Discrete Fourier Transform) output values correspond to received values of different cyclic shifts.

As an illustrative example:

Initialization: UE receives the necessary configuration parameters/configuration information; Some or all of the parameters or configuration may be signalled explicitly from gNB to UE. The signalling may be provided via RRC (radio resource control message) and/or MAC (media access control) message, and/or DCI (downlink control information provided via physical downlink control channel (PDCCH); Some parameters can be agreed upon in advance, e.g., may be determined at least partially by a standard or specification (e.g., cyclic shifts), and thus, UE may be pre-configured with some configuration information; Some parameters or configuration information may be determined implicitly, based on one or more signalled values. For example, certain cyclic shift values may be determined based on one signalled value.

Dynamic operation: UE may receive resource allocation for UCI (uplink control information); The resource allocation includes at least TDRA (time domain resource allocation), FDRA (frequency domain resource allocation), CDRA (code domain resource allocation), . . . and thus, may be notified of time-frequency resource allocation for the UE for uplink transmission; Resource allocation may be semi-static or dynamic, e.g., based on dynamic indication indicating one resource allocation from a set of configured resource allocations; The resource allocation depends also on the number of information bits X; RM (Reed Muller) encoding may be used; Performing channel selection for RM output, separately for each of the K symbols (or K segments of the codeword), with N bits per segment or symbol; Transmitting each of K symbols using the selected resources.

Some further examples will be provided.

Example 1. FIG. 5 is a flow chart illustrating operation of a transmitting node (e.g., a UE) according to an example embodiment. Operation 510 includes performing channel encoding on a plurality of information bits to obtain a codeword that includes a plurality of code bits. Operation 520 includes segmenting the codeword into a plurality of segments of code bits, wherein each segment of code bits includes a subset of code bits of the codeword. Operation 530 includes communicating a signal for each of the plurality of segments of code bits of the codeword based on a set of channel resources selected for each segment of code bits, including performing the following for each of the plurality of segments of code bits of the codeword: selecting (540), based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements; mapping (550) the selected base sequence onto the selected set of frequency domain resource elements; and transmitting (560) the selected and frequency mapped base sequence via an orthogonal frequency division multiplexing (OFDM) symbol.

Example 2. The method of example 1, wherein the transmitting comprises: transmitting, as part of a physical uplink control channel (PUCCH) transmission without transmitting a demodulation reference signal, the selected and frequency mapped base sequence via at least one of an orthogonal frequency division multiplexing (OFDM) symbol or a Discrete Fourier Transform-Spread OFDM (DFT-s-OFDM) symbol.

Example 3. The method of any of examples 1-2, further comprising performing the following for each of the plurality of segments of code bits of the codeword: performing a selected cyclic shift on the selected base sequence, based on the selected set of channel resources for the segment of code bits.

Example 4. The method of any of examples 1-3, wherein the transmitting comprises: performing an Inverse Fast Fourier Transform (IFFT) operation on the selected and frequency mapped base sequence; inserting a cyclic prefix (CP) to generate an output signal; and transmitting the output signal.

Example 5. The method of any of examples 1-4, wherein each set of channel resources may include an orthogonal or unique selection of at least one of: a base sequence selection, and a cyclic shift selection; a base sequence selection and a selected set of frequency domain resource elements or subcarriers; a cyclic shift selection; a cyclic shift selection and a physical resource block selection that includes adjacent physical resource blocks; a cyclic shift selection and a physical resource block selection that includes frequency hopping or non-adjacent physical resource blocks; a cyclic shift selection, a base sequence selection, and a frequency hopping physical resource block selection that uses non-adjacent physical resource blocks; a cyclic shift selection, and a comb or interleaved subcarrier selection; or a cyclic shift selection, a comb or interleaved subcarrier selection, and a physical resource block selection that includes frequency hopping or non-adjacent physical resource blocks.

Example 6. The method of any of examples 1-5, wherein the selecting, based on the segment of code bits, a set of channel resources, comprises: determining, based on the segment of code bits, a channel resource set index for the segment of code bits; and wherein the transmitting comprises transmitting a signal based on a set of channel resources associated with the channel resource set index, and via either one orthogonal frequency division multiplex (OFDM) symbol or one Discrete Fourier Transform-Spread OFDM (DFT-s-OFDM) symbol.

Example 7. The method of any of examples 1-6, wherein: a number of the segments of the codeword is equal to a number of (DFT-s-) OFDM symbols per transmission (K); the number of bits per segment equals to N; and the number of bits in the codeword is K*N.

Example 8. The method of any of examples 1-7, wherein the channel encoding comprises: performing Reed-Muller encoding on a plurality of information bits to obtain a codeword that includes a plurality of code bits.

Example 9. An apparatus comprising means for performing the method of any of examples 1-8.

Example 10. A non-transitory computer-readable storage medium comprising instructions stored thereon that, when executed by at least one processor, are configured to cause a computing system to perform the method of any of examples 1-8.

Example 11. An apparatus comprising: at least one processor; and at least one memory including computer program code; the at least one memory and the computer program code configured to, with the at least one processor, cause the apparatus at least to perform the method of any of examples 1-8.

Example 12. An apparatus comprising: at least one processor; and at least one memory including computer program code; the at least one memory and the computer program code configured to, with the at least one processor, cause the apparatus at least to: perform channel encoding on a plurality of information bits to obtain a codeword that includes a plurality of code bits; segment the codeword into a plurality of segments of code bits, wherein each segment of code bits includes a subset of code bits of the codeword; communicate a signal for each of the plurality of segments of code bits of the codeword based on a set of channel resources selected for each segment of code bits, including configured to perform the following for each of the plurality of segments of code bits of the codeword: select, based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements; map the selected base sequence onto the selected set of frequency domain resource elements; and transmit the selected and frequency mapped base sequence via an orthogonal frequency division multiplexing (OFDM) symbol.

Example 13. FIG. 6 is a flow chart illustrating operation of a receiving node (e.g., a gNB or other network node) according to an example embodiment. Operation 610 includes configuring a plurality of sets of channel resources, wherein each of the sets of channel resources includes a unique combination of channel resources including one or more of a selected base sequence, a cyclic shift and a selected set of frequency domain resource elements. Operation 620 includes receiving a plurality of signals via orthogonal frequency division multiplexing (OFDM) symbols, wherein each signal of the plurality of signals is associated with a unique combination of channel resources including one or more of a selected base sequence, a cyclic shift and a selected set of frequency domain resource elements. Operation 630 includes for each received signal and for each of the sets of channel resources, correlating the received signal on the set of frequency domain resource elements with the base sequence of the set of channel resources. Operation 640 includes associating an output of the correlating with a block of code bit values that is associated with a set of the channel resources, wherein each block of code bit values forms a segment of a codeword among a set of codewords, wherein each codeword corresponds to a plurality of information bits via channel encoding. And, operation 650 includes detecting a plurality of information bits based on outputs of the correlating, for the received plurality of signals.

Example 14. The method of example 13, wherein the receiving comprises: receiving, as part of a physical uplink control channel (PUCCH) transmission without receiving a demodulation reference signal, a plurality of signals via at least one of an orthogonal frequency division multiplexing (OFDM) symbol or a Discrete Fourier Transform-Spread OFDM (DFT-s-OFDM) symbol.

Example 15. The method of any of examples 13-14, wherein each set of channel resources may include an orthogonal or unique selection of at least one of: a base sequence selection, and a cyclic shift selection; a base sequence selection and a selected set of frequency domain resource elements or subcarriers; a cyclic shift selection; a cyclic shift selection and a physical resource block selection that includes adjacent physical resource blocks; a cyclic shift selection and a physical resource block selection that includes frequency hopping or non-adjacent physical resource blocks; a cyclic shift selection, a base sequence selection, and a frequency hopping physical resource block selection that uses non-adjacent physical resource blocks; a cyclic shift selection, and a comb or interleaved subcarrier selection; or a cyclic shift selection, a comb or interleaved subcarrier selection, and a physical resource block selection that includes frequency hopping or non-adjacent physical resource blocks.

Example 16. The method of any of examples 13-15, wherein the channel encoding comprises Reed-Muller encoding on a plurality of information bits to the codeword that includes a plurality of code bits.

Example 17. An apparatus comprising means for performing the method of any of examples 13-16.

Example 18. A non-transitory computer-readable storage medium comprising instructions stored thereon that, when executed by at least one processor, are configured to cause a computing system to perform the method of any of examples 13-16.

Example 19. An apparatus comprising: at least one processor; and at least one memory including computer program code; the at least one memory and the computer program code configured to, with the at least one processor, cause the apparatus at least to perform the method of any of examples 13-16.

Example 20. An apparatus comprising: at least one processor; and at least one memory including computer program code; the at least one memory and the computer program code configured to, with the at least one processor, cause the apparatus at least to: configure a plurality of sets of channel resources, wherein each of the sets of channel resources includes a unique combination of channel resources including one or more of a selected base sequence, a cyclic shift and a selected set of frequency domain resource elements; receive a plurality of signals via orthogonal frequency division multiplexing (OFDM) symbols, wherein each signal of the plurality of signals is associated with a unique combination of channel resources including one or more of a selected base sequence, a cyclic shift and a selected set of frequency domain resource elements; for each received signal and for each of the sets of channel resources, correlate the received signal on the set of frequency domain resource elements with the base sequence of the set of channel resources; associate an output of the correlating with a block of code bit values that is associated with a set of the channel resources, wherein each block of code bit values forms a segment of a codeword among a set of codewords, wherein each codeword corresponds to a plurality of information bits via channel encoding; and detect a plurality of information bits based on outputs of the correlating, for the received plurality of signals.

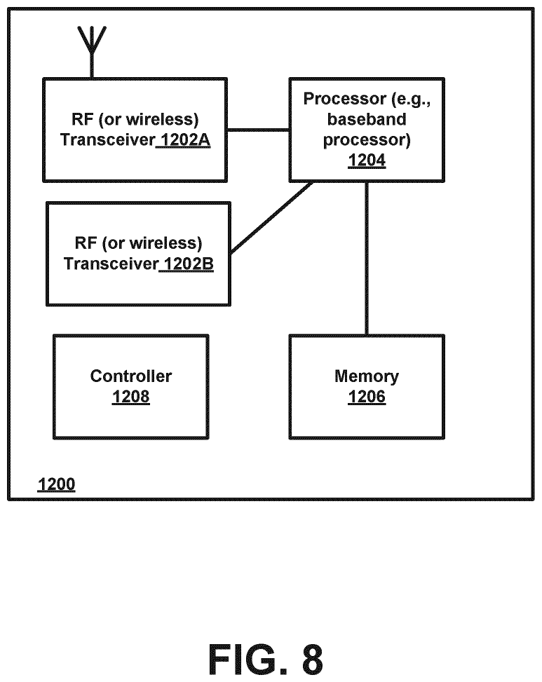

FIG. 8 is a block diagram of a wireless station (e.g., user node, network node, or other node) 1200 according to an example embodiment. The wireless station 1200 may include, for example, one or more (e.g., two as shown in FIG. 8) RF (radio frequency) or wireless transceivers 1202A, 1202B, where each wireless transceiver includes a transmitter to transmit signals and a receiver to receive signals. The wireless station also includes a processor or control unit/entity (controller) 1204 to execute instructions or software and control transmission and receptions of signals, and a memory 1206 to store data and/or instructions.

Processor 1204 may also make decisions or determinations, generate frames, packets or messages for transmission, decode received frames or messages for further processing, and other tasks or functions described herein. Processor 1204, which may be a baseband processor, for example, may generate messages, packets, frames or other signals for transmission via wireless transceiver 1202 (1202A or 1202B). Processor 1204 may control transmission of signals or messages over a wireless network, and may control the reception of signals or messages, etc., via a wireless network (e.g., after being down-converted by wireless transceiver 1202, for example). Processor 1204 may be programmable and capable of executing software or other instructions stored in memory or on other computer media to perform the various tasks and functions described above, such as one or more of the tasks or methods described above. Processor 1204 may be (or may include), for example, hardware, programmable logic, a programmable processor that executes software or firmware, and/or any combination of these. Using other terminology, processor 1204 and transceiver 1202 together may be considered as a wireless transmitter/receiver system, for example.

In addition, referring to FIG. 8, a controller (or processor) 1208 may execute software and instructions, and may provide overall control for the station 1200, and may provide control for other systems not shown in FIG. 8, such as controlling input/output devices (e.g., display, keypad), and/or may execute software for one or more applications that may be provided on wireless station 1200, such as, for example, an email program, audio/video applications, a word processor, a Voice over IP application, or other application or software.

In addition, a storage medium may be provided that includes stored instructions, which when executed by a controller or processor may result in the processor 1204, or other controller or processor, performing one or more of the functions or tasks described above.

According to another example embodiment, RF or wireless transceiver(s) 1202A/1202B may receive signals or data and/or transmit or send signals or data. Processor 1204 (and possibly transceivers 1202A/1202B) may control the RF or wireless transceiver 1202A or 1202B to receive, send, broadcast or transmit signals or data.

The embodiments are not, however, restricted to the system that is given as an example, but a person skilled in the art may apply the solution to other communication systems. Another example of a suitable communications system is the 5G concept. It is assumed that network architecture in 5G may be similar to that of LTE-advanced. 5G is likely to use multiple input-multiple output (MIMO) antennas, many more base stations or nodes than LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations may be carried out, at least partly, in a server, host or node may be operationally coupled to a remote radio head. It is also possible that node operations will be distributed among a plurality of servers, nodes or hosts. It should also be understood that the distribution of labour between core network operations and base station operations may differ from that of the LTE or even be non-existent.

Embodiments of the various techniques described herein may be implemented in digital electronic circuitry, or in computer hardware, firmware, software, or in combinations of them. Embodiments may be implemented as a computer program product, i.e., a computer program tangibly embodied in an information carrier, e.g., in a machine readable storage device or in a propagated signal, for execution by, or to control the operation of, a data processing apparatus, e.g., a programmable processor, a computer, or multiple computers. Embodiments may also be provided on a computer readable medium or computer readable storage medium, which may be a non-transitory medium. Embodiments of the various techniques may also include embodiments provided via transitory signals or media, and/or programs and/or software embodiments that are downloadable via the Internet or other network(s), either wired networks and/or wireless networks. In addition, embodiments may be provided via machine type communications (MTC), and also via an Internet of Things (IoT).

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers.

Furthermore, embodiments of the various techniques described herein may use a cyber-physical system (CPS) (a system of collaborating computational elements controlling physical entities). CPS may enable the embodiment and exploitation of massive amounts of interconnected ICT devices (sensors, actuators, processors microcontrollers, . . . ) embedded in physical objects at different locations. Mobile cyber physical systems, in which the physical system in question has inherent mobility, are a subcategory of cyber-physical systems. Examples of mobile physical systems include mobile robotics and electronics transported by humans or animals. The rise in popularity of smartphones has increased interest in the area of mobile cyber-physical systems. Therefore, various embodiments of techniques described herein may be provided via one or more of these technologies.

A computer program, such as the computer program(s) described above, can be written in any form of programming language, including compiled or interpreted languages, and can be deployed in any form, including as a standalone program or as a module, component, subroutine, or other unit or part of it suitable for use in a computing environment. A computer program can be deployed to be executed on one computer or on multiple computers at one site or distributed across multiple sites and interconnected by a communication network.

Method steps may be performed by one or more programmable processors executing a computer program or computer program portions to perform functions by operating on input data and generating output. Method steps also may be performed by, and an apparatus may be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer, chip or chipset. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magnetooptical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magnetooptical disks; and CDROM and DVD-ROM disks. The processor and the memory may be supplemented by, or incorporated in, special purpose logic circuitry.

To provide for interaction with a user, embodiments may be implemented on a computer having a display device, e.g., a cathode ray tube (CRT) or liquid crystal display (LCD) monitor, for displaying information to the user and a user interface, such as a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments may be implemented in a computing system that includes a backend component, e.g., as a data server, or that includes a middleware component, e.g., an application server, or that includes a frontend component, e.g., a client computer having a graphical user interface or a Web browser through which a user can interact with an embodiment, or any combination of such backend, middleware, or frontend components. Components may be interconnected by any form or medium of digital data communication, e.g., a communication network. Examples of communication networks include a local area network (LAN) and a wide area network (WAN), e.g., the Internet.

While certain features of the described embodiments have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

1-20. (canceled)

21. A method comprising:
performing channel encoding on a plurality of information bits to obtain a codeword that includes a plurality of code bits;
segmenting the codeword into a plurality of segments of code bits, wherein each segment of code bits includes a subset of code bits of the codeword;
communicating a signal for each of the plurality of segments of code bits of the codeword based on a set of channel resources selected for each segment of code bits; and for each of the plurality of segments of code bits of the codeword:
selecting, based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements;
mapping the selected base sequence onto the selected set of frequency domain resource elements; and
transmitting the selected and frequency mapped base sequence via an orthogonal frequency division multiplexing symbol.

22. The method of claim 21, wherein the transmitting comprises:
transmitting, as part of a physical uplink control channel transmission without transmitting a demodulation reference signal, the selected and frequency mapped base sequence via at least one of an orthogonal frequency division multiplexing symbol or a discrete Fourier transform-spread orthogonal frequency division multiplexing symbol.

23. The method of claim 21, further comprising:
performing, for each of the plurality of segments of code bits of the codeword, a selected cyclic shift on the selected base sequence, based on the selected set of channel resources for the segment of code bits.

24. The method of claim 21, wherein the transmitting comprises:
performing an inverse fast Fourier transform operation on the selected and frequency mapped base sequence;
inserting a cyclic prefix to generate an output signal; and
transmitting the output signal.

25. The method of claim 21, wherein each set of channel resources may include an orthogonal or unique selection of at least one of:
a base sequence selection, and a cyclic shift selection;
a base sequence selection and a selected set of frequency domain resource elements or subcarriers;
a cyclic shift selection;
a cyclic shift selection and a physical resource block selection that includes adjacent physical resource blocks;
a cyclic shift selection and a physical resource block selection that includes frequency hopping or non-adjacent physical resource blocks;
a cyclic shift selection, a base sequence selection, and a frequency hopping physical resource block selection that uses non-adjacent physical resource blocks;
a cyclic shift selection, and a comb or interleaved subcarrier selection; or
a cyclic shift selection, a comb or interleaved subcarrier selection, and a physical resource block selection that includes frequency hopping or non-adjacent physical resource blocks.

26. The method of claim 21, wherein the selecting, based on the segment of code bits, a set of channel resources, comprises:
determining, based on the segment of code bits, a channel resource set index for the segment of code bits, and wherein the transmitting comprises:
transmitting a signal based on a set of channel resources associated with the channel resource set index, and via either one orthogonal frequency division multiplex symbol or one discrete Fourier transform-spread orthogonal frequency division multiplex symbol.

27. The method of claim 21, wherein:
a number of the segments of the codeword is equal to a number of discrete Fourier transform-spread orthogonal frequency division multiplex symbols per transmission (K);
the number of bits per segment equals to N; and
the number of bits in the codeword is K*N.

28. The method of claim 21, wherein performing the channel encoding comprises: performing Reed-Muller encoding on a plurality of information bits to obtain a codeword that includes a plurality of code bits.

29. An apparatus comprising:
at least one processor; and
at least one memory including computer program code;
the at least one memory and the computer program code configured to, with the at least one processor, cause the apparatus at least to:
perform channel encoding on a plurality of information bits to obtain a codeword that includes a plurality of code bits;
segment the codeword into a plurality of segments of code bits, wherein each segment of code bits includes a subset of code bits of the codeword;
communicate a signal for each of the plurality of segments of code bits of the codeword based on a set of channel resources selected for each segment of code bits; and for each of the plurality of segments of code bits of the codeword:
select, based on the segment of code bits, a set of channel resources, wherein each set of channel resources is selected among a plurality of sets of channel resources, wherein each of the sets of channel resources includes a unique combination of channel resources including one or more of a selected base sequence, a cyclic shift and a selected set of frequency domain resource elements;
map the selected base sequence onto the selected set of frequency domain resource elements; and
transmit the selected and frequency mapped base sequence via an orthogonal frequency division multiplexing symbol.

30. The apparatus of claim 29, wherein the transmitting comprises:
transmitting, as part of a physical uplink control channel transmission without transmitting a demodulation reference signal, the selected and frequency mapped base sequence via at least one of an orthogonal frequency division multiplexing symbol or a discrete Fourier transform-spread orthogonal frequency division multiplexing symbol.

31. The apparatus of claim 29, further comprising:
performing, for each of the plurality of segments of code bits of the codeword, a selected cyclic shift on the selected base sequence, based on the selected set of channel resources for the segment of code bits.

32. The apparatus of claim 29, wherein the transmitting comprises:
performing an inverse fast Fourier transform operation on the selected and frequency mapped base sequence;
inserting a cyclic prefix to generate an output signal; and
transmitting the output signal.

33. The apparatus of claim 29, wherein each set of channel resources may include an orthogonal or unique selection of at least one of:
a base sequence selection, and a cyclic shift selection;
a base sequence selection and a selected set of frequency domain resource elements or subcarriers;
a cyclic shift selection;
a cyclic shift selection and a physical resource block selection that includes adjacent physical resource blocks;
a cyclic shift selection and a physical resource block selection that includes frequency hopping or non-adjacent physical resource blocks;
a cyclic shift selection, a base sequence selection, and a frequency hopping physical resource block selection that uses non-adjacent physical resource blocks;
a cyclic shift selection, and a comb or interleaved subcarrier selection; or
a cyclic shift selection, a comb or interleaved subcarrier selection, and a physical resource block selection that includes frequency hopping or non-adjacent physical resource blocks.

34. The apparatus of claim 29, wherein the selecting, based on the segment of code bits, a set of channel resources, comprises:
determining, based on the segment of code bits, a channel resource set index for the segment of code bits, and wherein the transmitting comprises:
transmitting a signal based on a set of channel resources associated with the channel resource set index, and via either one orthogonal frequency division multiplex symbol or one discrete Fourier transform-spread orthogonal frequency division multiplex symbol.

35. The apparatus of claim 29, wherein:
a number of the segments of the codeword is equal to a number of discrete Fourier transform-spread orthogonal frequency division multiplex symbols per transmission (K);
the number of bits per segment equals to N; and
the number of bits in the codeword is K*N.

36. The apparatus of claim 29, wherein the channel encoding comprises:
performing Reed-Muller encoding on a plurality of information bits to obtain a codeword that includes a plurality of code bits.

37. An apparatus comprising:
at least one processor; and
at least one memory including computer program code;
the at least one memory and the computer program code configured to, with the at least one processor, cause the apparatus at least to:
configure a plurality of sets of channel resources, wherein each of the sets of channel resources includes a unique combination of channel resources including one or more of a selected base sequence, a cyclic shift and a selected set of frequency domain resource elements;
receive a plurality of signals via orthogonal frequency division multiplexing symbols, wherein each signal of the plurality of signals is associated with a unique combination of channel resources including one or more of a selected base sequence, a cyclic shift and a selected set of frequency domain resource elements; and for each received signal and for each of the sets of channel resources:
correlate the received signal on the set of frequency domain resource elements with the base sequence of the set of channel resources;
associate an output of the correlating with a block of code bit values that is associated with a set of the channel resources, wherein each block of code bit values forms a segment of a codeword among a set of codewords, wherein each codeword corresponds to a plurality of information bits via channel encoding; and
detect a plurality of information bits based on outputs of the correlating, for the received plurality of signals.

38. The apparatus of claim 37, wherein the receiving comprises:
receiving, as part of a physical uplink control channel transmission without receiving a demodulation reference signal, a plurality of signals via at least one of an orthogonal frequency division multiplexing symbol or a discrete Fourier transform-spread orthogonal frequency division multiplexing symbol.

39. The apparatus of claim 37, wherein each set of channel resources may include an orthogonal or unique selection of at least one of:
a base sequence selection, and a cyclic shift selection;
a base sequence selection and a selected set of frequency domain resource elements or subcarriers;
a cyclic shift selection;
a cyclic shift selection and a physical resource block selection that includes adjacent physical resource blocks;
a cyclic shift selection and a physical resource block selection that includes frequency hopping or non-adjacent physical resource blocks;
a cyclic shift selection, a base sequence selection, and a frequency hopping physical resource block selection that uses non-adjacent physical resource blocks;
a cyclic shift selection, and a comb or interleaved subcarrier selection; or
a cyclic shift selection, a comb or interleaved subcarrier selection, and a physical resource block selection that includes frequency hopping or non-adjacent physical resource blocks.

40. The apparatus of claim 37, wherein the channel encoding comprises Reed-Muller encoding on a plurality of information bits to the codeword that includes a plurality of code bits.
